(19) United States
(12) Patent Application Publication
(10) Pub. No.: US 2008/0148964 A1
(43) Pub. Date: Jun. 26, 2008

(54) Frying-Roasting Device and Its Baking Tray

(75) Inventors: Chiaming Shen, Xiamen (CN); Tzuhui Chen, Xiamen (CN); Tsungyi Chuang, Xiamen (CN)

Correspondence Address: BAKER DONELSON BEARMAN CALDWELL & BERKOWITZ, PC, 555 11TH STREET, NW, 6TH FLOOR, WASHINGTON, DC, 20004, US

(73) Assignee: TSANN KUEN (CHINA) ENTERPRISE CO., LTD., Xiamen (CN)

(21) Appl. No.: 11/877,539

(22) Filed: Oct. 23, 2007

(30) Foreign Application Priority Data
Oct. 26, 2006 (CN) 200610069490.6

(51) Int. Cl. A47J 37/04; B65D 1/34; B65D 1/36

(52) U.S. Cl. 99/427; 206/557; 206/564

(57) ABSTRACT

A baking tray which comprises an upper surface, a nether surface opposite to the upper surface, an even number of openings through the upper surface and the nether surface, and a cant located in the inner lateral wall of the opening, wherein the inclination between the cant and the nether surface is less than the inclination between the cant and the upper surface. Also disclosed is a frying or roasting device comprising the baking tray.

### FIELD OF INVENTION

The present invention relates to a frying-roasting device, particularly to a frying-roasting device and its baking tray, of which it is convenient to take food out.

### BACKGROUND OF THE INVENTION

The frying-roasting device is widely used because of its convenience for using. FIG. 1 is the three-dimensional explosive view of a known frying-roasting device 100. The frying-roasting device 100 comprises an upper lid 110, an upper heating subassembly 120, an upper baking tray 130, a nether baking tray 140, a nether heating subassembly 150 and a base 160; wherein the nether baking tray 140 has an even number of model patterns 142. Users can bake food with different shapes and different sizes conveniently. However, the known frying-roasting device 100 has disadvantages as follows: when taking food items (such as a biscuit) out from the model pattern 142 of the nether baking tray 140, the food items usually crack destroying the shape of the food.

### SUMMARY OF THE INVENTION

The purpose of the present invention is to overcome the disadvantages of the inconvenience of taking out food from known frying-roasting devices, to provide a frying-roasting device that is convenient to take food out, to attain the aim of improving the integrality of food.

The present invention is accomplished by using an even number of openings in the baking tray to get through the upper surface and the nether surface of the baking tray; a cant located on the inner lateral wall of the opening, and the inclination between the cant and the nether surface being less than the inclination between the cant and the upper surface, to make the food shaped in the baking tray capable of being taken out from the opening of the baking tray expediently via pushing food out of the baking tray from the opening of the nether surface.

Another purpose of the present invention is to provide a frying-roasting device which has a baking tray with an opening through the upper surface and the nether surface of the baking tray; users can push food out of the baking tray by the opening to improve the integrality of food, which solves the problem of cracking of food when taking food out from the known frying-roasting device.

In another preferred embodiment of the present invention, the baking tray comprises an upper surface, a nether surface opposite to the upper surface, at least an opening through the upper surface and the nether surface, and a cant located in the inner lateral wall of the opening, wherein the inclination between the cant and the nether surface is less than the inclination between the cant and the upper surface.

In another preferred embodiment of the present invention, the frying-roasting device at least comprises a shell, a baking tray module and a heater. The shell consists of an upper lid and a base opposite to the upper lid. The baking tray module is located in the shell and at least comprises a baking tray, an upper baking tray and a nether baking tray. The baking tray comprises an upper surface, a nether surface opposite to the upper surface, at least an opening through the upper surface and the nether surface, and a cant located in the inner lateral wall of the opening, wherein the inclination between the cant and the nether surface is less than the inclination between the cant and the upper surface. The upper baking tray is located above the baking tray and the nether baking tray is located under the baking tray. The heater is located in the shell, which is used to heat the baking tray module.

According to a preferred embodiment of the present invention, the heater can be an electrothermal tube or an electrothermal plate.

The frying-roasting device has the following advantages: there are openings in the baking tray to improve the integrality of food, compared with other known frying-roasting devices, the present invention can take food out from the baking tray expediently, solving the problem of cracking of food when taking food out from the known frying-roasting device. In addition, the cant of the opening of the baking tray of the present invention not only can prevent the food shaped in the baking tray from sliding from the opening, but also can push food from the baking tray making use of the opening, to improve the integrality of food, to solve the problem of cracking of food when taking food from the known baking tray.

### BRIEF DESCRIPTION OF THE DRAWINGS

FIG. 1 is a three-dimensional explosive view of known frying-roasting device.

FIG. 2A is a three-dimensional explosive view of the frying-roasting device of one preferred embodiment of the present invention.

FIG. 2B is a three-dimensional perspective view of the frying-roasting device in FIG. 2A.

FIG. 2C is a diagram of the side elevation of the section of the baking tray module FIG. 2A.

FIG. 2D is a diagram of the side elevation of the section of the baking tray module of another preferred embodiment of the present invention.

FIG. 2E is a diagram of how food is taken out from the baking tray in FIG. 2D.

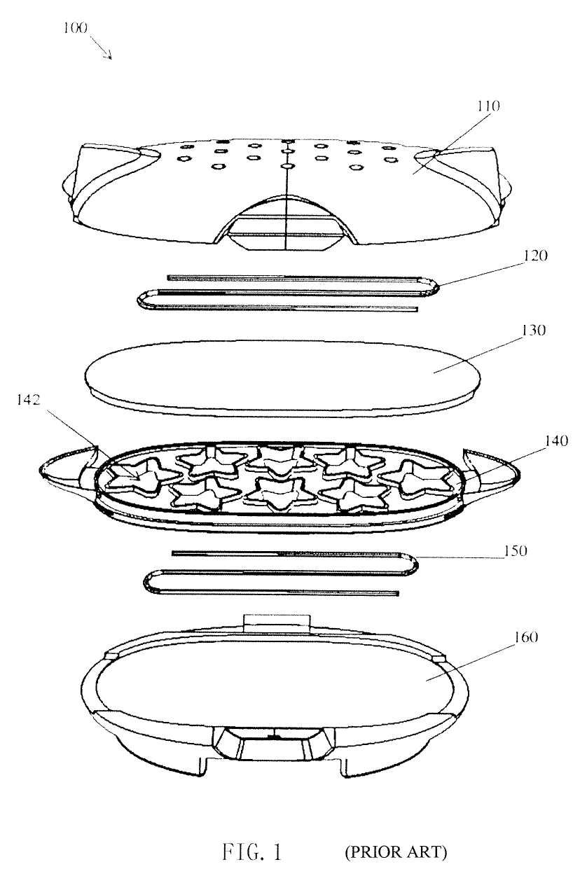

### DETAILED DESCRIPTION OF PREFERRED EMBODIMENTS

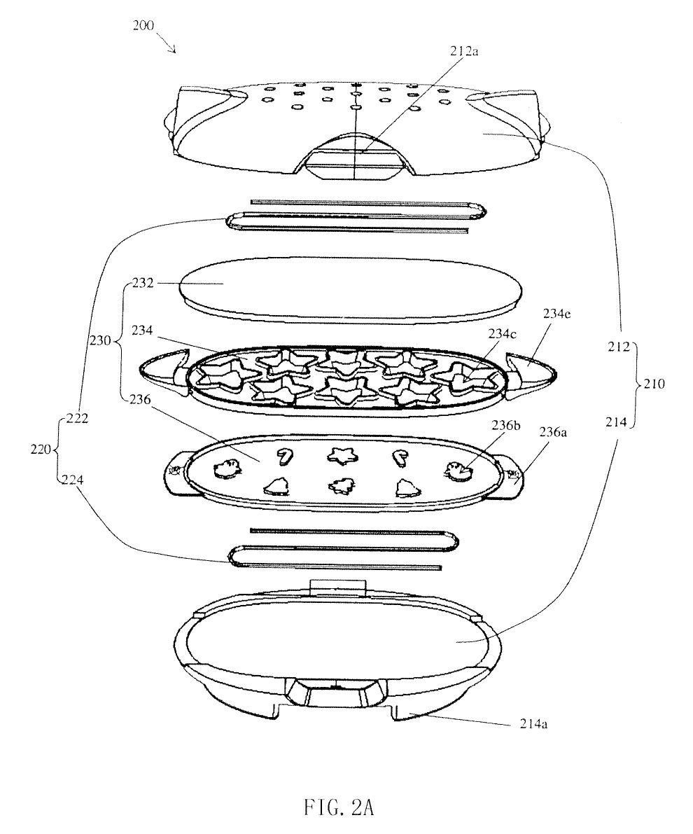

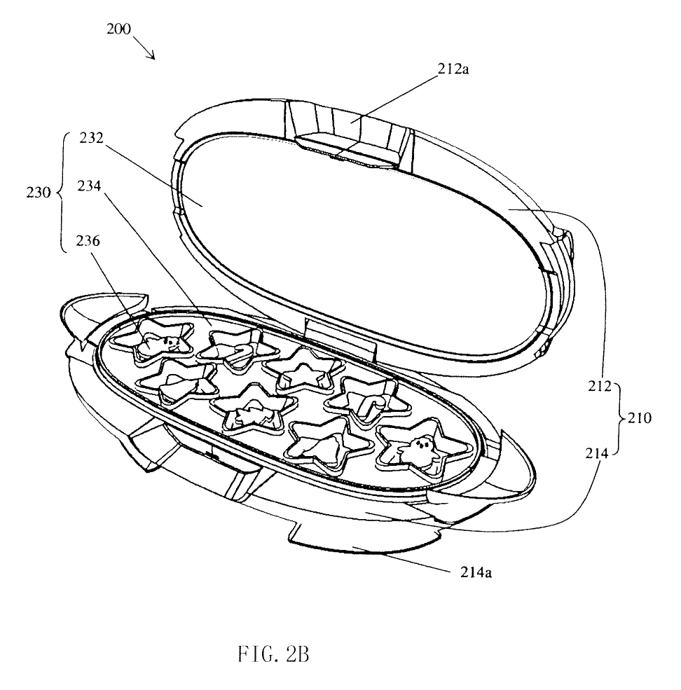

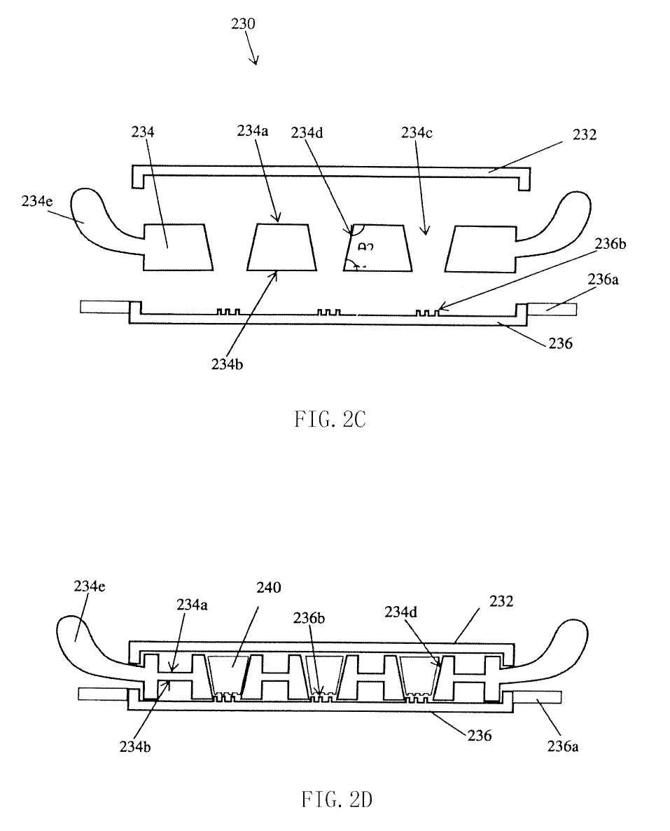

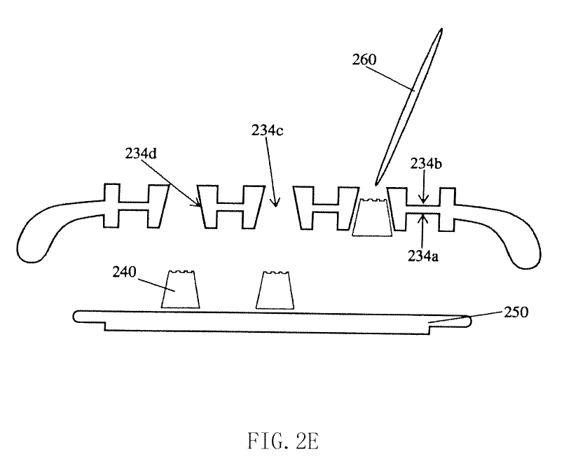

Embodiment 1, referring to FIGS. 2A and 2B, is a three-dimensional breakdown drawing and a three-dimensional diagram of the frying-roasting device 200 of embodiment 1 of the present invention. In the present embodiment, the frying-roasting device 200 is a biscuit machine for making biscuits, but it is not restricted to making biscuits. For example, it can be used in making muffins or other food. The frying-roasting device 200 comprises a shell 210, a heater 220 and a baking tray module 230; wherein the shell 210 comprises an upper lid 212 and a base 214 opposite to the upper lid 212, and the upper lid 212 is connected to the base 214 by pin joint. A handle 212a is set on the upper lid 212 for lifting the upper lid 212 to make the baking tray 230 basset. An even number of supporting feet 214a are set on the base 214 to make the base 214 higher than the working table. Bottoms of the supporting feet 214a have skid-proof cushions to prevent the slide of the supporting feet 214a. The heater 220 comprises an upper heating subassembly 222 located in the upper lid 212 and a nether heating subassembly 224 located in the base 214; the heating subassemblies 222 and 224 are used to heat the baking tray module 230. In the present embodiment, the heating subassemblies 222 and 224 are electrothermal tubes, but are not limited to electrothermal tubes as they also can be electrothermal plates or other heating devices that can be adjacent to the baking tray module 230 and can heat the baking tray module 230. The baking tray module 230 is located in the shell 210 and comprises an upper baking tray 232, a baking tray 234 and a nether baking tray 236. The upper baking tray 232 is located on the upper lid 212; the nether baking tray 236 is located on the base 214 of the knock-down; the nether baking tray 236 is located under the baking tray 234. The baking tray 234 has the structure of shaped food (such as a biscuit), comprising an upper surface 234a, a nether surface 234b opposite to the upper surface 234a, an even number of openings 234c through the upper surface 234a and the nether surface 234b, as shown in FIG. 2C. A cant 234d is located in the inner lateral wall of every opening 234c, wherein the inclination between the cant 234d and the nether surface 234b is less than the inclination between the cant 234d and the upper surface 234a. In addition, there are handles 234e and 236a on the baking tray 234 and the nether baking tray 236 respectively, which makes it easy to take the baking tray 234 and the nether baking tray 236.

In addition, to reduce the weight of the baking tray 234 and the cost of materials, the thickness of the upper surface 234a and the nether surface 234b can be reduced besides the cant 234d for shape of food 240 in the inner lateral wall of openings 234c, as shown in FIG. 2D, which is a diagram of side elevation of the section of the baking tray module of another preferred embodiment of the present invention.

In addition, even numbers of patterns 236b are located on the nether baking tray 236 to make the food in the openings 234c have different shapes. In the present embodiment, the patterns 236b are raised patterns, but not being limited to this, sunk patterns also can be used. It is easily understood that raised patterns are located in the openings 234c of the baking tray 234 and sunk patters are located oppositely to the openings 234c of the baking tray 234. In the present embodiment, the patterns 236b are drawings, but not being limited to drawings, as they also can be characters or figures or signs. In addition, the shape of the opening 234c is a drawing, and the size of the opening 234c is bigger than the size of the pattern 236b.

When users desire to take food 240 out from the frying-roasting device 200, firstly taking the baking tray 234 out from the frying-roasting device 200, the food 240 in the opening 234c will not fall off the baking tray 234 from the nether surface 234b on account of the presence of the cant 234d, but can only fall off the baking tray 234 from the upper surface 234a, so users can carry food making use of the baking tray 234. Then, as shown in FIG. 2E, turning over the upper surface 234a of the baking tray 234, the food can easily fall off the baking tray 234 from the opening 234c and fall into the dishware 250 by the weight of the food 240 and gradient angle of the cant 234d. If there is still some food in the baking tray 234, users can push food 240 out of the baking tray 234 by chopsticks 260 or dishware or fingers or other tools through the opening 234c located in the nether surface 234b.

In conclusion, the frying-roasting device of the present invention has characters of the baking tray module being divided into three parts: an upper baking tray, a baking tray and a nether baking tray, and there are openings for pushing food in the baking tray for taking food out easily. Compared to other known frying-roasting devices, the present invention can take food out from the baking tray conveniently, solving the problem of cracking of food when taking food out from known frying-roasting devices. In addition, the cant of the opening of the baking tray of the present invention not only can prevent the food shaped in the baking tray from sliding from the opening, but also can push food from the baking tray making use of the opening, to improve the integrality of food, and to solve the problem of cracking of food when taking food from known baking tray.

According to above preferred embodiment, both the baking tray and the nether baking tray of the baking tray module are knock-down, and the baking tray and the nether baking tray have openings and drawings to determine the shape of food, so users can make food with different shapes by replacing the baking tray with a different opening shape and the nether baking tray with a different drawing shape.

While the present invention has been described in connection with what is considered the most practical and preferred embodiments, it is understood that the present invention is not limited to the disclosed embodiments but is intended to cover various arrangements included within the spirit and scope of the broadest interpretation so as to encompass all such modifications and equivalent arrangements.

1. A baking tray, comprising:
an upper surface, a nether surface opposite to the upper surface, at least an opening through the upper surface and the nether surface, and
a cant located in an inner lateral wall of the opening, wherein an inclination between the cant and the nether surface is less than an inclination between the cant and the upper surface.

2. The baking tray according to claim 1, further comprising:
an upper baking tray located above the upper surface; a nether baking tray located under the nether surface.

3. The baking tray according to claim 2, wherein:
a pattern is located on the nether baking tray, and the pattern is a drawing or character or figure or sign.

4. The baking tray according to claim 3, wherein the pattern is a raised pattern located in the opening of the baking tray.

5. The baking tray according to claim 3, wherein the pattern is a sunk pattern located opposite to the opening of the baking tray.

6. The baking tray according to claim 3, wherein the opening is bigger in size than the size of the pattern.

7. The baking tray according to claim 1, wherein the shape of the opening is a drawing.

8. A frying-roasting device comprising:
a shell, comprising an upper lid and a base opposite to the upper lid;
a baking tray module located in the shell, wherein the baking tray module comprises:
a baking tray, which comprises an upper surface, a nether surface opposite to the upper surface, at least an opening through the upper surface and the nether surface, and a cant located in the inner lateral wall of the opening, wherein an inclination between the cant and the nether surface is less than an inclination between the cant and the upper surface; and
a heater located in the shell.

9. The frying-roasting device according to claim 8, wherein the baking tray module comprises:
an upper baking tray located on the upper lid and located above the baking tray; and
a nether baking tray installed on the base of a knock-down and located under the baking tray, and the baking tray is installed above the nether baking tray.

10. The frying-roasting device according to claim 9, further comprising:
a handle located on the baking tray or the nether baking tray.

11. The frying-roasting device according to claim 9, further comprising:
a pattern located on the nether baking tray, and the pattern is a drawing or character or figure or sign.

12. The frying-roasting device according to claim 11, wherein the pattern is a raised pattern located in the opening of the baking tray.

13. The frying-roasting device according to claim 11, wherein the pattern is a sunk pattern located opposite to the opening of the baking tray.

14. The frying-roasting device according to claim 11, wherein the size of the opening is bigger than the size of the pattern.

15. The frying-roasting device according to claim 8 wherein the shape of the opening is a drawing.
